(19) United States
(12) Patent Application Publication
(10) Pub. No.: US 2022/0335310 A1
(43) Pub. Date: Oct. 20, 2022

(54) DETECT UN-INFERABLE DATA

(71) Applicant: International Business Machines Corporation, Armonk, NY (US)

(72) Inventors: June-Ray Lin, Taipei City (TW); Jing Xu, Xi'an (CN); Si Er Han, Xi'an (CN); Xue Ying Zhang, Xi'an (CN)

(21) Appl. No.: 17/230,072

(22) Filed: Apr. 14, 2021

(51) Int. Cl. G06N 5/04; G06N 20/00

(52) U.S. Cl. CPC G06N 5/04; G06N 20/00

(57) ABSTRACT

An approach is provided in which a method, system, and program product identify a plurality of models to test a set of data. Each one of the plurality of models produces one of a plurality of predictions corresponding to one of a plurality of targets. The method, system, and program product detect one or more conflicts between the plurality of predictions in response to testing the set of data against each of plurality of models. The method, system, and program product report an un-inferable result of the testing in response to detecting the one or more conflicts.

### BACKGROUND

Artificial intelligence uses machine learning algorithms to build models based on sample data (training data) to make predictions or decisions on a topic without being explicitly programmed to make the predictions or decisions on the topic. Machine learning algorithms are used in a wide variety of applications where developing conventional algorithms to perform needed tasks is difficult or unfeasible.

The accuracy level of a machine learning model is based its “true positives,” “true negatives,” “false positives,” and “false negatives.” A true positive is an outcome where the machine learning model correctly predicts a positive class. A true negative is an outcome where the machine learning model correctly predicts a negative class. A false positive is an outcome where the machine learning model incorrectly predicts a positive class. And, a false negative is an outcome where the machine learning model incorrectly predicts a negative class.

When a machine learning model generates a false positive outcome, the machine learning model may be attempting to predict an outcome that is not predictable, referred to herein as “un-inferable.” A machine learning model is required to predict a particular result even though the prediction is with low confidence. When a system uses multiple machine learning models to reach a final outcome, users are not able to tell whether conflicts existed between the individual outcomes of the different machine learning models and subsequently generating a false positive final outcome. Although there are workaround approaches, such as creating an “others” class of results, these approaches do not function in binary classifications.

### BRIEF SUMMARY

According to one embodiment of the present disclosure, an approach is provided in which a method, system, and program product identify a plurality of models to test a set of data. Each one of the plurality of models produces one of a plurality of predictions corresponding to one of a plurality of targets. The method, system, and program product detect one or more conflicts between the plurality of predictions in response to testing the set of data against each of plurality of models. The method, system, and program product report an un-inferable result of the testing in response to detecting the one or more conflicts.

According to another embodiment of the present disclosure, an approach is provided in which a method, system, and program product generate, by a first one of the models, a strong first prediction corresponding to a first one of the plurality of targets. The method, system, and program product generate, by a second one of the models, a strong second prediction corresponding to a second one of the plurality of targets. The method, system, and program product then generate the un-inferable result in response to determining that the first target is different from the second target.

According to yet another embodiment of the present disclosure, an approach is provided in which a method, system, and program product determine the strong first prediction based on a first mean plus two standard deviations area on a first probability curve corresponding to the first model, and determine the strong second prediction based on a second mean plus two standard deviations area on a second probability curve corresponding to the second model.

According to yet another embodiment of the present disclosure, an approach is provided in which a method, system, and program product build the plurality of models based on a set of training data. The method, system, and program product compute, for each of the plurality of models, one of a plurality of model evaluation measures that measure a performance of one of the plurality of models. The method, system, and program product then select a subset of models (K) from the plurality of models based on their corresponding model evaluating measures, wherein the K models comprise a set of important features.

According to yet another embodiment of the present disclosure, an approach is provided in which a method, system, and program product rank the set of important features corresponding to the K models. The method, system, and program product identify a set of distinct features based on the ranking. For each of the set of distinct features, the method, system, and program product

select one of the set of distinct features and remove a portion of the training data corresponding to the selected distinct feature. The method, system, and program product test the each of the K models on a subset of the training data that excludes the removed portion of the training data, and select one of the K models based on the testing. The method, system, and program product designate the selected K model as one of a set of S models and utilize the set of S models during the testing of the set of data to detect the one or more conflicts.

According to yet another embodiment of the present disclosure, an approach is provided in which a method, system, and program product determine a confidence threshold for each S model in the set of S models. The method, system, and program product then utilize the confidence threshold to determine whether one or more of the plurality of predictions is a strong prediction.

According to yet another embodiment of the present disclosure, an approach is provided in which a method, system, and program product determine that the plurality of predictions include a plurality of strong first predictions that each correspond to a first one of the plurality of targets. The method, system, and program product determine that the plurality of predictions include a single strong second prediction that corresponds to a second one of the plurality of targets. The method, system, and program product then report the un-inferable result in response to determining that the first target is different from the second target.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is an exemplary diagram depicting a system that generates machine learning models, selects a portion of the machine learning models for conflict analysis, and uses the selected machine learning models to determine whether an output result is un-inferable;

FIG. 4 is an exemplary flowchart depicting steps taken to evaluate predictive models and select the best predictive models for conflict analysis;

FIG. 5 is an exemplary flowchart depicting steps taken in a leave one out cross validation process to select a group of models for conflict analysis;

FIG. 6 is an exemplary flowchart depicting steps taken during runtime processing to determine whether any strong conflicts arise during conflict analysis;

FIG. 7 is an exemplary diagram depicting training data that includes a set of features and targets;

FIG. 8 is an exemplary diagram depicting confidence thresholds for S models;

FIG. 9 is an exemplary diagram depicting a predictive model decision tree that includes strong prediction confidence nodes and weak to medium prediction confidence nodes; and

FIG. 10 is an exemplary diagram depicting various score data model results.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

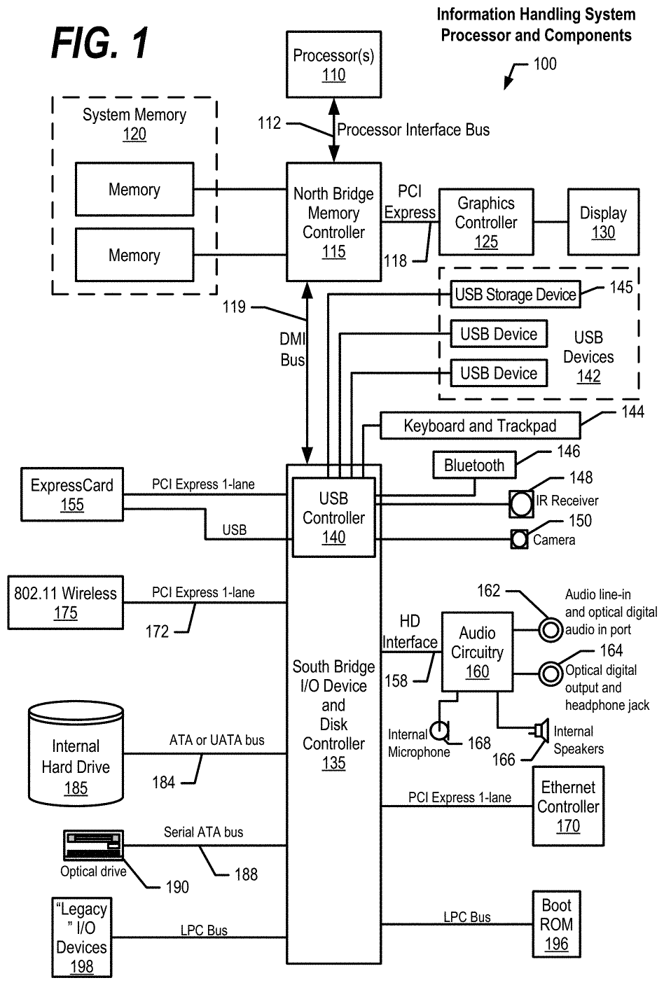

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, Peripheral Component Interconnect (PCI) Express bus 118 connects Northbridge 115 to graphics controller 125. Graphics controller 125 connects to display device 130, such as a computer monitor.

Northbridge 115 and Southbridge 135 connect to each other using bus 119. In some embodiments, the bus is a Direct Media Interface (DMI) bus that transfers data at high speeds in each direction between Northbridge 115 and Southbridge 135. In some embodiments, a PCI bus connects the Northbridge and the Southbridge. Southbridge 135, also known as the Input/Output (I/O) Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and Universal Serial Bus (USB) connectivity as it connects to Southbridge 135 using both the USB and the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, Integrated Services Digital Network (ISDN) connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the Institute of Electrical and Electronic Engineers (IEEE) 802.11 standards of over-the-air modulation techniques that all use the same protocol to wireless communicates between information handling system 100 and another computer system or device. Optical storage device 190 connects to Southbridge 135 using Serial Analog Telephone Adapter (ATA) (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality associated with audio hardware such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, Automated Teller Machine (ATM), a portable telephone device, a communication device or other devices that include a processor and memory.

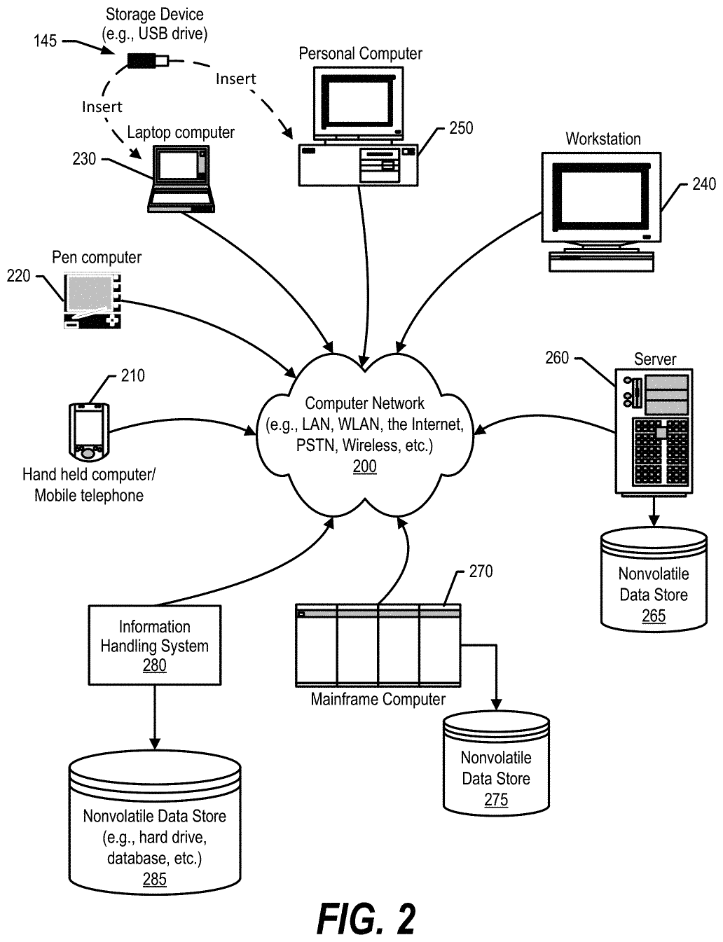

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as Moving Picture Experts Group Layer-3 Audio (MP3) players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. The embodiment of the information handling system shown in FIG. 2 includes separate nonvolatile data stores (more specifically, server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

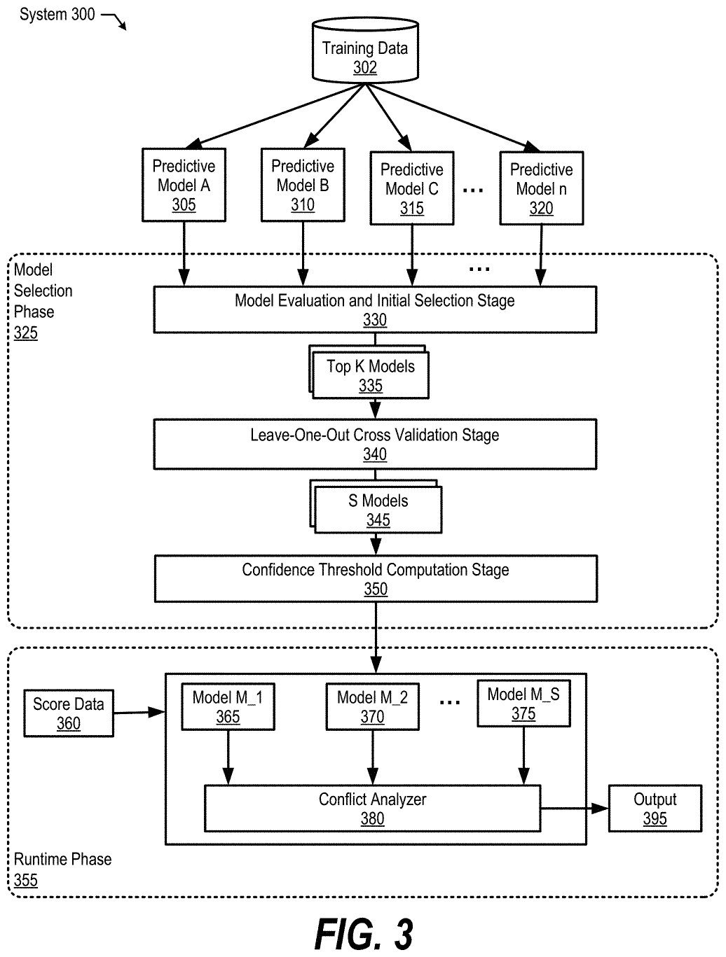

As discussed above, machine learning models are always required to predict a result and therefore at times generate false positive results. FIGS. 3 through 10 depict an approach that can be executed on an information handling system that determines whether two different machine learning models generate different strong predictions for two different targets. When this occurs, the approach produces and un-inferable result. As discussed in detail below, the approach uses training data to build N models with different parameter settings and/or model types. For each model, the approach computes thresholds for classifying prediction confidences and selects a set of the models for conflict analysis (S models). The approach then uses the S models to analyze score data and, if the S models generate strong predictions for different targets, the approach outputs an un-inferable result.

FIG. 3 is an exemplary diagram depicting a system that generates machine learning models, selects a portion of the machine learning models for conflict analysis, and uses the selected machine learning models to determine whether an output result is un-inferable.

System 300 uses training data 302 to generate an initial set of predictive models 305, 310, 315, and 320. System 300 begins model selection phase 325 using model evaluation and initial selection stage 330 to select top K models 335. During model evaluation and initial selection stage 330, system 300 uses metrics to evaluate a classification model such as a using a Percent Correction Classification (PCC) and/or a Confusion matrix. Percent Correction Classification (PCC) measures overall accuracy and every error has the same weight. A Confusion matrix also measures accuracy but distinguishes between errors (e.g., false positives, false negatives, and correct predictions).

Similarly, system 300 may use metrics to evaluate a regression model such as R-squared, Average error, Mean Square Error (MSE), Median error, Average absolute error, and/or Median absolute error. R-squared generates a goodness of fit metric that ranges between 0 and 1, where the higher value indicates a higher coherence and predictive ability of the model. Average error is the numerical difference between the predicted value and the actual value. Mean Square Error (MSE) may be a preferred approach when many outliers exist in the data. Median error is the average of all differences between the predicted values and the actual values. Average absolute error is similar to the average error except that the absolute value of the difference balances out the outliers in the data. Median absolute error is the average of the absolute differences between predictions and actual observations. The individual differences have equal weight and allow big outliers to affect the final evaluation of the model.

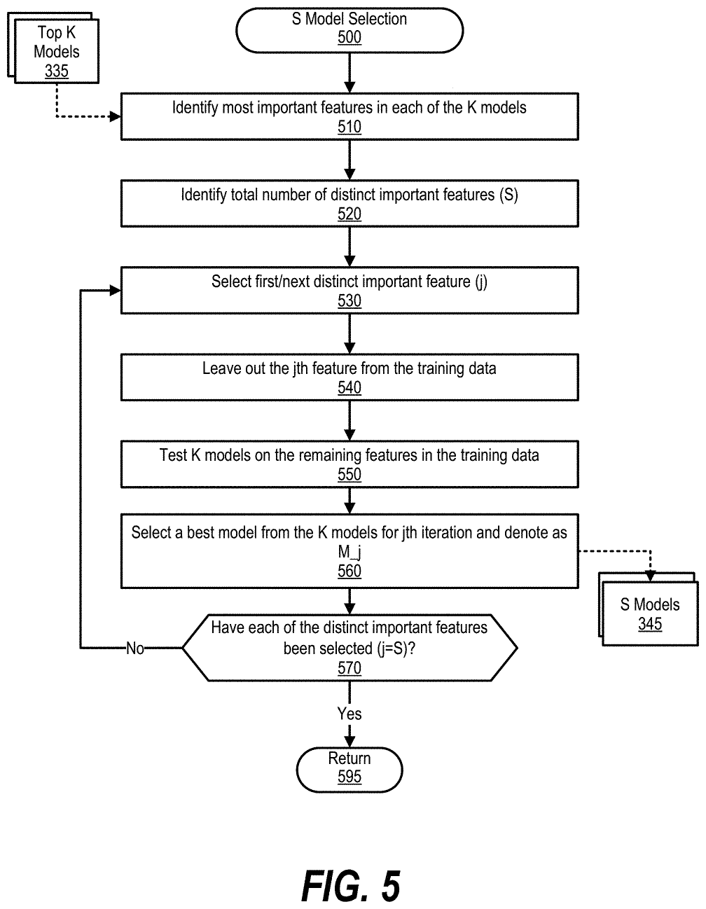

After top K models 335 selection, system 300 then performs leave-one-out cross validation stage 340 to determine which of top K models 345 should be used for conflict analysis. FIG. 5 shows detail steps of leave-one-out cross validation stage 340 and S models 345 selection. Confidence threshold computation stage 350 determines thresholds where strong predictions start of each of S models 345. Confidence threshold computation stage 350 may use several approaches of computing or assigning a confidence threshold to a given model. For example, a user may rely on his/her field knowledge to set a confidence threshold, or confidence threshold confidence computation stage 350 computes the confidence threshold as a mean+2 std, where “mean” is the average confidence value of a model and “std” is the standard deviation. System 300 then loads S models 345 and their corresponding confidence thresholds into runtime phase 355, shown as model M_1 365, M_2 370, and model M_S 375.

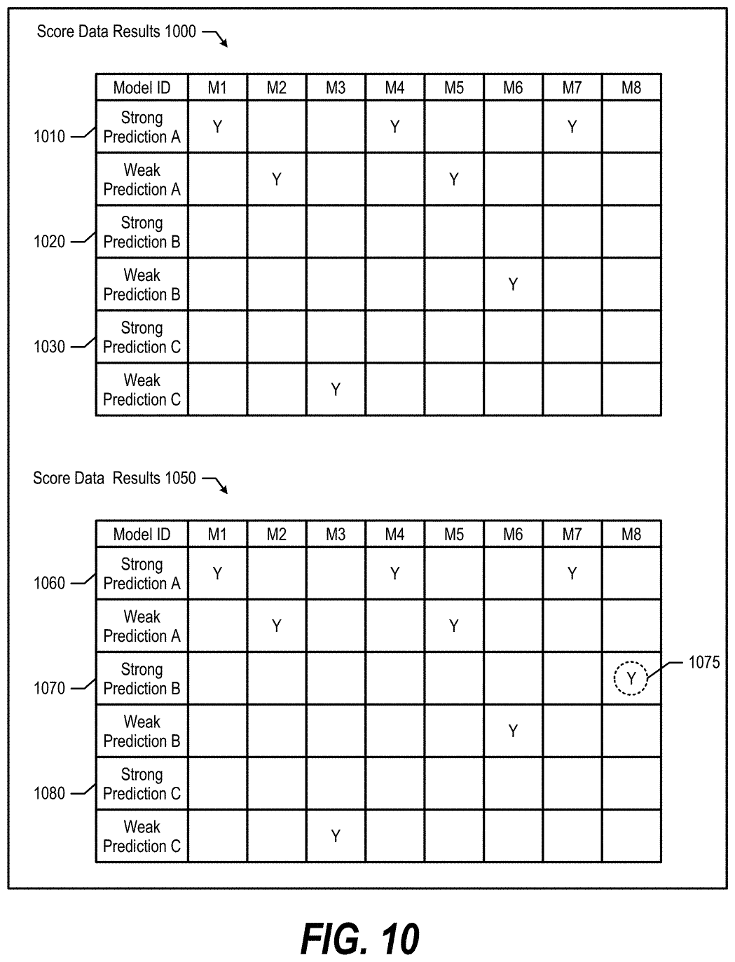

During runtime phase 355, score data 360 is analyzed by each of the S models 365, 370, and 375. Conflict analyzer 380 evaluates the results of the S models and determines output 395. When the output of models 365, 370, or 375 produce strong predictions for different targets, such as strong prediction “A” and strong prediction “B,” conflict analyzer 380 generates an un-inferable result as output 395. For example, if model M_1 365 and model M_2 370 produce a strong prediction for target A, but model M_S 375 produces a strong prediction for target B, conflict analyzer 380 outputs an un-inferable result (see FIG. 10, score data results 1050 and corresponding text for further details).

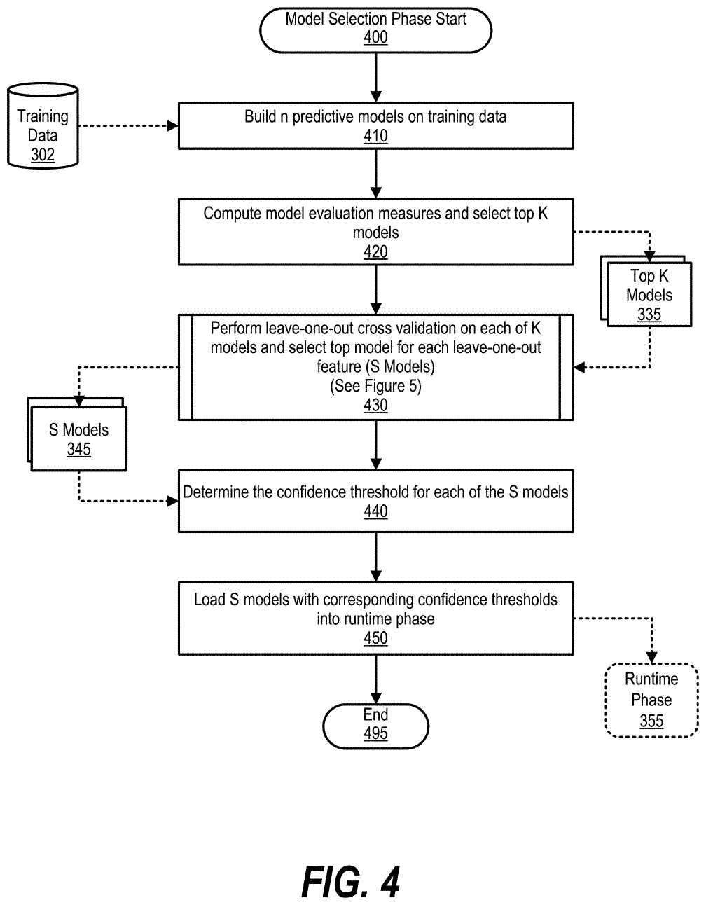

FIG. 4 is an exemplary flowchart depicting steps taken to evaluate predictive models and select the best predictive models for conflict analysis. FIG. 4 processing commences at 400 whereupon, at step 410, the process builds n predictive models using training data 302.

At step 420, the process computes model evaluation measures and selects top K models 335. As discussed above, several approaches may be used to evaluate and select the top K models. For example, metrics that can be used for evaluation a classification model include Percent Correction Classification (PCC) and/or a Confusion matrix. Metrics that can be used for evaluation a classification model include R-squared, Average error, Mean Square Error (MSE), Median error, Average absolute error, and/or Median absolute error.

At predefined process 430, the process performs leave-one-out cross validation steps on each of the K models and selects a top model (S Model) for each leave-one-out feature iteration, resulting in multiple S models (see FIG. 5 and corresponding text for processing details).

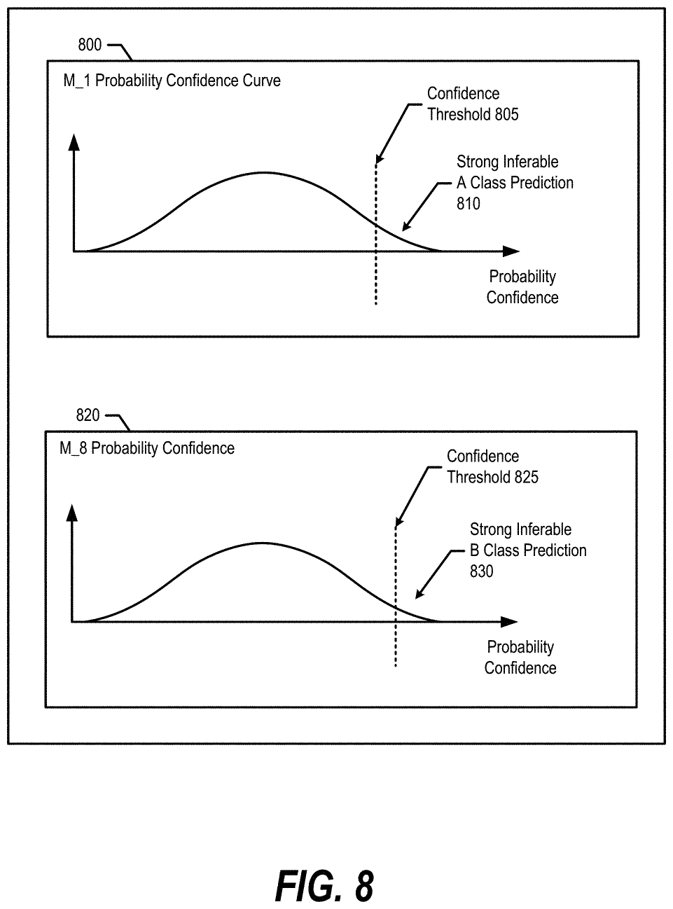

At step 440, the process determines confidence thresholds for each of the S models. For example, data groups with significantly high confidence are strong, such as >mean+2*std. (see FIG. 8 and corresponding text for further details). At step 450, the process loads S models 345 with their corresponding confidence thresholds into runtime phase 355 and FIG. 4 processing thereafter ends at 495.

FIG. 5 is an exemplary flowchart depicting steps taken in a leave one out cross validation process to select a group of models (S models) for conflict analysis. FIG. 5 processing commences at 500 whereupon, at step 510, the process identifies the most important features in each of K models 335 and, at step 520, the process identifies a total number of distinct important features (S). In one embodiment, each of K models 335 may have a slightly different set of most important features. In this embodiment, assuming the total number of distinct important features is S, the process labels the total most important features from 1 to S.

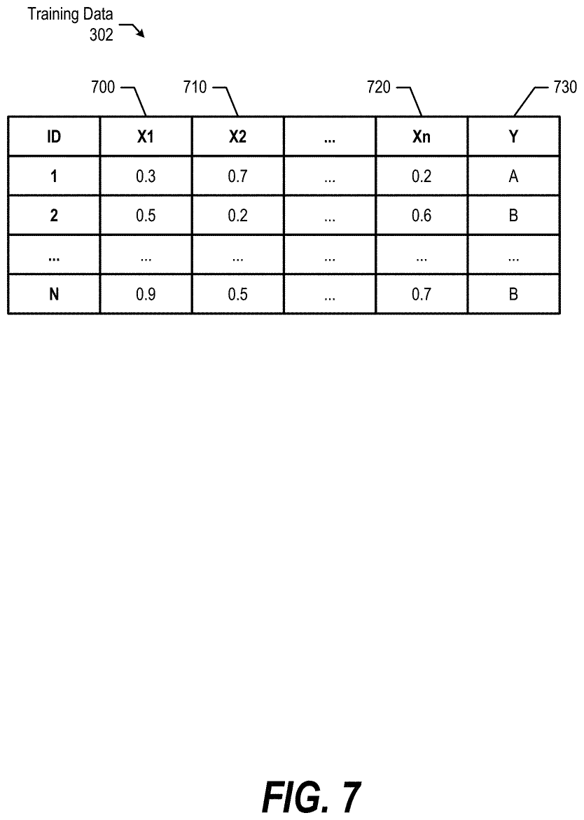

At step 530, the process selects the first distinct important feature (“j”). At step 540, the process leaves out the jth feature from the training data. Referring to FIG. 7, during the first iteration of j=1, the process leaves out column 700 corresponding to feature X1 in training data 302.

At step 550, the process tests each of K models 335 on the remaining features in the training data. At step 560, the process selects a best (e.g., most accurate) one of the K models for the jth iteration and denotes the selected model as an MJ S Model 345 (e.g., Model M_1).

The process determines as to whether each of the distinct important features have been processed (j=S) (decision 570). If each of the distinct important features have not been processed (j=S), then decision 570 branches to the ‘yes’ branch which loops back to select and process the next distinct important feature. Note that for the next iteration, the process brings back in the previously left out data so just the particular jth column of data is left out for the next iteration. This looping continues until each of the distinct important features have been selected, at which point decision 570 branches to the “yes” branch exiting the loop. FIG. 5 processing thereafter returns to the calling routine (see FIG. 4) at 595.

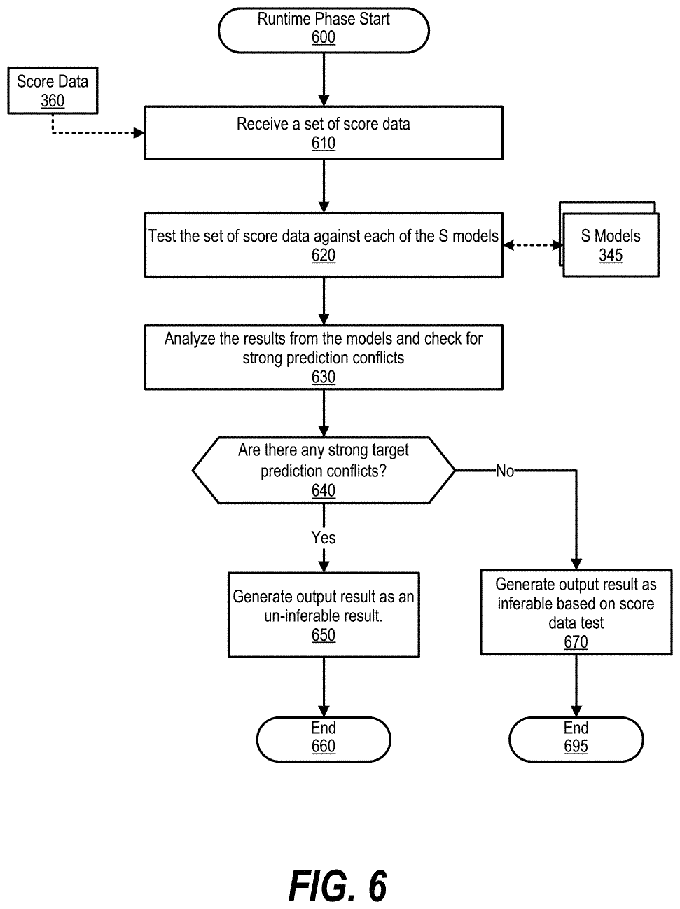

FIG. 6 is an exemplary flowchart depicting steps taken during runtime processing to determine whether to generate an un-inferable result. FIG. 6 processing commences at 600 whereupon, at step 610, the process receives a set of score data 360. At step 620, the process tests the set of score data against each of the selected S models 345 (e.g., conflict analyzer 380).

At step 630, the process analyzes the results from the S models and checks for strong target prediction conflicts. Referring to FIG. 10, score data results 1000 show a single strong prediction in row 1010 for target A and, as such, score data results 1000 do not have a conflict. However, score data results 1050 shows a strong prediction for target A in row 1060 and also shows a strong prediction in row 1070 for target B. Therefore, score data results 1050 have conflicts.

The process determines as to whether there are any strong prediction conflicts (decision 640). If there are any strong prediction conflicts, then decision 640 branches to the ‘yes’ branch whereupon, at step 650, the process generates an output result 395 as an un-inferable result and FIG. 6 processing thereafter ends at 660.

On the other hand, if there are not any strong prediction conflicts, then decision 640 branches to the ‘no’ branch whereupon, at step 670, the process generates an output result based on the score data test (e.g., strong inference target A) and FIG. 6 processing thereafter ends at 695.

FIG. 7 is an exemplary diagram depicting training data 302 that includes a set of features and targets. FIG. 7 shows training data 302, which includes multiple records in rows 1 through n. Each column 700, 710, and 720 is a feature, also referred to as a “predictor.” Column 730 is a target column that includes targets for the various rows. The example in FIG. 7 shows that the targets in column 730 are categorical targets. In one embodiment, the targets can be continuous variable targets or a combination of categorical targets and continuous variable targets.

As discussed herein, model selection phase 325 uses training data 302 to create the initial predictive models and also performs leave-one-out cross validation steps that removes data from one feature column at a time to eventually select S models 345.

FIG. 8 is an exemplary diagram depicting probability confidence curves and strong confidence thresholds for S models. Graph 800 shows a probability confidence curve for S model M_1. Graph 800 shows a strong inferable A class prediction 810 at the mean+2 standard deviations (confidence threshold 805).

Graph 820 shows a probability confidence curve for S model M_8. Graph 820 shows a strong inferable B class prediction 840 at the mean+2 standard deviations (confidence threshold 825). Referring to FIG. 10, score data results 1050, when score data 360 produces a strong prediction A from model M_1 and a strong prediction B from model M_8, conflict analyzer 380 determines that output 395 is un-inferable. As discussed herein and comparing confidence threshold 805 to confidence threshold 825, strong confidence threshold levels may be at different locations along different probability curves for different models.

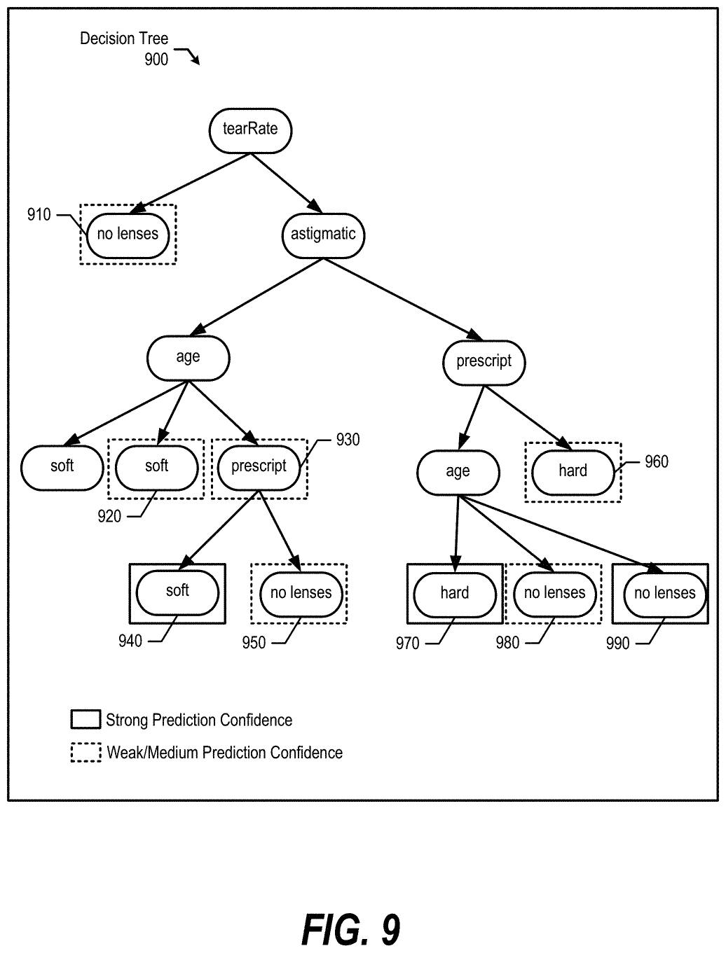

FIG. 9 is an exemplary diagram depicting a predictive model decision tree that includes strong prediction confidence nodes and weak to medium prediction confidence nodes. Decision tree 900 corresponds to a predictive model and its decision points.

During threshold confidence computation stage 350, the predictive model nodes are analyzed for their individual confidence levels. FIG. 9 shows that nodes 940, 970, and 990 correspond to strong prediction confidences. As such, when the corresponding predictive model makes a determination based on these nodes, the predictive model outputs a strong prediction inference. Nodes 910, 920, 930, 950, 960, and 980 correspond to a week to medium prediction confidence. As such when the corresponding predictive model makes a determination based on these nodes, the determination is not relevant in regards to conflict analysis but is relevant when strong conflicts do not exist between different predictive models (see FIG. 6 and corresponding text for further details).

FIG. 10 is an exemplary diagram depicting various score data model results. Score data results 1000 show column results of models M1 through M8. Each of the rows corresponds to a strong prediction or a weak prediction of a particular target. Row 1010, 1020, and 1030 include the strong prediction results used during conflict analysis. As can be seen, the only row with strong prediction results is row 1010, where models M1, M4, M7 all agree on strong prediction A. Therefore, score data results 1000 do not have any strong target prediction conflicts and output 395 will indicate a strong prediction A inference.

However, score data results 1050 show a strong target prediction conflict. Row 1060 shows that model M1, M4, and M7 produce a strong target prediction for target A. Row 1070, however, shows that model M8 generates a strong target prediction for target B (1075). Therefore, score data results 1050 will generate an un-inferable output even though a majority of the strong predictions are for target A.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, suchf420 intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A computer-implemented method comprising:
identifying a plurality of models to test a set of data, wherein each one of the plurality of models produces one of a plurality of predictions corresponding to one of a plurality of targets;
detecting one or more conflicts between the plurality of predictions in response to testing the set of data against each of plurality of models; and
reporting an un-inferable result of the testing in response to detecting the one or more conflicts.

2. The computer-implemented of claim 1 wherein the plurality of models comprises a first model and a second model, the method further comprising:
generating, by the first model, a strong first prediction corresponding to a first one of the plurality of targets;
generating, from the second model, a strong second prediction corresponding to a second one of the plurality of targets; and
generating the un-inferable result in response to determining that the first target is different from the second target.

3. The computer-implemented method of claim 2 wherein the strong first prediction is based on a first mean plus two standard deviations confidence threshold on a first probability curve corresponding to the first model, and wherein the strong second prediction is based on a second mean plus two standard deviations confidence threshold on a second probability curve corresponding to the second model.

4. The computer-implemented method of claim 1 further comprising:
building the plurality of models based on a set of training data;
computing, for each of the plurality of models, one of a plurality of model evaluation measures that measure a performance of one of the plurality of models; and
selecting a K subset of models from the plurality of models based on their corresponding model evaluating measures, wherein the K subset of models comprises a set of important features.

5. The computer-implemented method of claim 4 further comprising:
ranking the set of important features corresponding to the K subset of models;
identifying a set of distinct features based on the ranking;
for each of the set of distinct features:
selecting one of the set of distinct features;
removing a portion of the training data corresponding to the selected distinct feature;
testing the each of the K subset of models on a subset of the training data that excludes the removed portion of the training data; and
selecting one of the K subset of models based on the testing; and
designating the selected K subset of models as one of a set of S models; and
utilizing the set of S models during the testing of the set of data to detect the one or more conflicts.

6. The computer-implemented method of claim 5 further comprising:
determining a confidence threshold for each one of the S models in the set of S models; and
utilizing the confidence threshold to determine whether one or more of the plurality of predictions is a strong prediction.

7. The computer-implemented method of claim 1 further comprising:
determining that the plurality of predictions comprise a plurality of strong first predictions that each correspond to a first one of the plurality of targets;
determining that the plurality of predictions comprise a single strong second prediction that corresponds to a second one of the plurality of targets; and
reporting the un-inferable result in response to determining that the first target is different from the second target.

8. An information handling system comprising:
one or more processors;
a memory coupled to at least one of the processors;
a set of computer program instructions stored in the memory and executed by at least one of the processors in order to perform actions of:
identifying a plurality of models to test a set of data, wherein each one of the plurality of models produces one of a plurality of predictions corresponding to one of a plurality of targets;
detecting one or more conflicts between the plurality of predictions in response to testing the set of data against each of plurality of models; and
reporting an un-inferable result of the testing in response to detecting the one or more conflicts.

9. The information handling system of claim 8 wherein the plurality of models comprises a first model and a second model, and wherein the processors perform additional actions comprising:
generating, by the first model, a strong first prediction corresponding to a first one of the plurality of targets;
generating, from the second model, a strong second prediction corresponding to a second one of the plurality of targets; and
generating the un-inferable result in response to determining that the first target is different from the second target.

10. The information handling system of claim 9 wherein the strong first prediction is based on a first mean plus two standard deviations confidence threshold on a first probability curve corresponding to the first model, and wherein the strong second prediction is based on a second mean plus two standard deviations confidence threshold on a second probability curve corresponding to the second model.

11. The information handling system of claim 8 wherein the processors perform additional actions comprising:
building the plurality of models based on a set of training data;
computing, for each of the plurality of models, one of a plurality of model evaluation measures that measure a performance of one of the plurality of models; and
selecting a K subset of models from the plurality of models based on their corresponding model evaluating measures, wherein the K subset of models comprises a set of important features.

12. The information handling system of claim 11 wherein the processors perform additional actions comprising:
ranking the set of important features corresponding to the K subset of models;
identifying a set of distinct features based on the ranking;
for each of the set of distinct features:
selecting one of the set of distinct features;
removing a portion of the training data corresponding to the selected distinct feature;
testing the each of the K subset of models on a subset of the training data that excludes the removed portion of the training data; and
selecting one of the K subset of models based on the testing; and
designating the selected K subset of models as one of a set of S models; and
utilizing the set of S models during the testing of the set of data to detect the one or more conflicts.

13. The information handling system of claim 12 wherein the processors perform additional actions comprising:
determining a confidence threshold for each one of the S models in the set of S models; and
utilizing the confidence threshold to determine whether one or more of the plurality of predictions is a strong prediction.

14. The information handling system of claim 8 wherein the processors perform additional actions comprising:
determining that the plurality of predictions comprise a plurality of strong first predictions that each correspond to a first one of the plurality of targets;
determining that the plurality of predictions comprise a single strong second prediction that corresponds to a second one of the plurality of targets; and
reporting the un-inferable result in response to determining that the first target is different from the second target.

15. A computer program product stored in a computer readable storage medium, comprising computer program code that, when executed by an information handling system, causes the information handling system to perform actions comprising:
identifying a plurality of models to test a set of data, wherein each one of the plurality of models produces one of a plurality of predictions corresponding to one of a plurality of targets;
detecting one or more conflicts between the plurality of predictions in response to testing the set of data against each of plurality of models; and
reporting an un-inferable result of the testing in response to detecting the one or more conflicts.

16. The computer program product of claim 15 wherein the plurality of models comprises a first model and a second model, and wherein the information handling system performs further actions comprising:
generating, by the first model, a strong first prediction corresponding to a first one of the plurality of targets;
generating, from the second model, a strong second prediction corresponding to a second one of the plurality of targets; and
generating the un-inferable result in response to determining that the first target is different from the second target.

17. The computer program product of claim 16 wherein the strong first prediction is based on a first mean plus two standard deviations confidence threshold on a first probability curve corresponding to the first model, and wherein the strong second prediction is based on a second mean plus two standard deviations confidence threshold on a second probability curve corresponding to the second model.

18. The computer program product of claim 15 wherein the information handling system performs further actions comprising:
building the plurality of models based on a set of training data;
computing, for each of the plurality of models, one of a plurality of model evaluation measures that measure a performance of one of the plurality of models; and
selecting a K subset of models from the plurality of models based on their corresponding model evaluating measures, wherein the K subset of models comprises a set of important features.

19. The computer program product of claim 18 wherein the information handling system performs further actions comprising:
ranking the set of important features corresponding to the K subset of models;
identifying a set of distinct features based on the ranking;
for each of the set of distinct features:
selecting one of the set of distinct features;
removing a portion of the training data corresponding to the selected distinct feature;
testing the each of the K subset of models on a subset of the training data that excludes the removed portion of the training data; and
selecting one of the K subset of models based on the testing; and
designating the selected K subset of models as one of a set of S models; and
utilizing the set of S models during the testing of the set of data to detect the one or more conflicts.

20. The computer program product of claim 19 wherein the information handling system performs further actions comprising:
determining a confidence threshold for each one of the S models in the set of S models; and
utilizing the confidence threshold to determine whether one or more of the plurality of predictions is a strong prediction.
